(19) United States
(12) Patent Application Publication
(10) Pub. No.: US 2004/0127602 A1
(43) Pub. Date: Jul. 1, 2004

(54) Surface-coated magnesium hydroxide

(76) Inventors: Joachim Schaeling, Troisdorf (DE); Rene Herbiet, Eupen (BE); Hans Peter Hillekamps, Erkelenz-Immerath (DE)

Correspondence Address: MANELLI DENISON & SELTER, 2000 M STREET NW SUITE 700, WASHINGTON, DC, 20036-3307, US

(21) Appl. No.: 10/474,164

(22) PCT Filed: Apr. 2, 2002
(86) PCT No.: PCT/EP02/03641

(30) Foreign Application Priority Data
Apr. 5, 2001 (EP) 01108643.6

(51) Int. Cl. C08K 9/00; C09C 1/36

(52) U.S. Cl. 523/200; 106/436; 106/450; 106/461; 523/210

(57) ABSTRACT

There are described surface-coated magnesium hydroxides with a coating of

(a) 0.2 to 5 wt.-%, relative to the magnesium hydroxide, of at least one compound from the group consisting of (i) fatty acids with 8 to 30 carbon atoms, (ii) alkylsilanes with at least one alkyl group with at least 3 carbon atoms, (iii) organic titanates and (iv) organic zirconates and

(b) 0.2 to 5 wt.-%, relative to the magnesium hydroxide, of an aminosilane.

The magnesium hydroxides according to the invention are characterized by a reduced tendency towards “blooming” when used as flame-retardant fillers in polyamides.

### DESCRIPTION

The invention relates to a surface-coated magnesium hydroxide with improved blooming behaviour when used as a filler in polyamides and also a process for its preparation.

Magnesium hydroxide is used as a flame-retardant filler in thermoplastic plastics, in particular in those, the processing temperature of which lies above the decomposition temperature of other flame retardants such as e.g. aluminium hydroxide. These plastics include in particular polyamides. In order to achieve a sufficient compatibility with the plastic, it is necessary to provide the magnesium hydroxide with a surface coating. As a rule, aminosilanes are used for this. However, it has transpired that, when using the customary aminosilane-coated magnesium hydroxides, blooming became visible on the surface of the end product after a climate-alternation test. The blooming consists of a whitish, adhering film which covers the entire surface area and makes the end product unsightly and gives rise to complaints. The customary climate-alternation test involves exposing the samples to a 100% relative air humidity alternately for 12 hours at room temperature, then for 12 hours at 40° C., then again for 12 hours at room temperature and so on. The whitish film forms after only a few weeks.

The object of the present invention was therefore the preparation of magnesium hydroxides with suitable coatings which do not give cause for any film to form or significantly reduce the tendency towards a film forming.

According to the invention, this object is achieved by the coated magnesium hydroxide according to patent claim 1 and the preparation process according to patent claim 10.

It was found that the desired properties can be achieved by coating a magnesium hydroxide with a combination of

(a) 0.2 to 5 wt.-%, relative to the magnesium hydroxide, of at least one compound from the group consisting of

(i) fatty acids with 8 to 30 carbon atoms,

(ii) alkylsilanes with at least one alkyl group with at least 3 carbon atoms,

(iii) organic titanates and

(iv) organic zirconates with

(b) 0.2 to 5 wt.-%, relative to the magnesium hydroxide, of an aminosilane.

The term “magnesium hydroxide” includes here and in the following not only the compound Mg(OH)₂, but also other natural or synthetic products which contain magnesium ions and, as anions, predominantly hydroxide ions. Suitable magnesium hydroxides are for example brucite, natural or synthetic magnesium hydroxycarbonates such as huntite or hydromagnesite, or synthetic magnesium hydroxides as sold for example by Alusuisse Martinswerk GmbH under the trade mark Magnifin®. It is of course also within the scope of the invention to use mixtures of the above-named magnesium hydroxides.

By alkyl groups is meant here and in the following in each case linear or branched primary, secondary or tertiary alkyl groups with the number of carbon atoms indicated in each case. Linear or single-branched primary or secondary alkyl groups such as for example methyl, ethyl, propyl, isopropyl, butyl, isobutyl, hexyl, octyl, isooctyl (6-methylheptyl), 2-ethylhexyl, dodecyl, tetradecyl, hexadecyl, octadecyl etc. are preferred. Correspondingly, by C₈₋₃₀ acyl groups is meant the groups, composed of one of the above-defined alkyl groups and a carbonyl group, with (together) 8 to 30 carbon atoms such as for example octanoyl (capryloyl), decanoyl (caprinoyl), dodecanoyl (lauroyl), tetradecanoyl (myristoyl), hexadecanoyl (palmitoyl), octadecanoyl (stearoyl), isooctadecanoyl (isostearoyl) etc.

The fatty acids, alkylsilanes, organic titanates or organic zirconates and also the aminosilanes, which can be used according to the invention, are known compounds and are frequently commercially available. Fatty acids are available in pure form or as mixtures under various brand names from the companies Cognis (formerly Henkel KGaA) or Unichema for example.

Alkylsilanes and aminosilanes are offered for sale for example by Degussa-Hüls AG under the brand Dynasylan® and organic titanates and zirconates by DuPont under the brand TYZOR®.

The commercially available compounds 3-aminopropyltrimethoxysilane and 3-aminopropyltriethoxysilane are preferably used as aminosilanes.

Both saturated and unsaturated fatty acids and also fatty acids with additional functional groups such as for example amino or hydroxy fatty acids can be used as fatty acids. Saturated fatty acids with 10 to 24 carbon atoms are preferably used. These can be used both as pure or industrially pure substances and also as homologue mixtures, as obtained for example in the splitting of natural fats.

The alkylsilanes that are preferably used can be described by the formula R¹Si(OR²)₃. R¹ means a linear or branched alkyl group with 3 to 30 carbon atoms and R² a linear or branched C₁₋₆ alkyl group. Alkylsilanes in which R¹ is a linear or branched alkyl group with 8 to 18, in particular however 12 to 14 carbon atoms and R² is a C₁₋₄ alkyl group are particularly preferred.

Preferably used organic titanates are those which can be described by the formula R³OTi(OR⁴)₃. R³ is a linear or branched C₁₋₁₂ alkyl group and R⁴ is a linear or branched C₆₋₁₂ alkyl or C₈₋₃₀ acyl group. The organic titanate in which R³ is isopropyl and R⁴ is isostearoyl is particularly preferred. The organic titanates in which R³ and R⁴ are the same and are isooctyl or 2-ethylhexyl are likewise particularly preferred.

Preferably used organic zirconates are those which can be described by the formula R⁵OZr(OR⁶)₃. R⁵ is a linear or branched C₁₋₁₂ alkyl and R⁶ is a linear or branched C₆₋₁₂ alkyl or C₈₋₃₀ acyl.

The surface-coated magnesium hydroxides according to the invention can be prepared by coating an untreated magnesium hydroxide in a suitable mixing device with

(a) 0.2 to 5 wt.-%, relative to the magnesium hydroxide, of at least one compound from the group consisting of (i) fatty acids with 8 to 30 carbon atoms, (ii) alkylsilanes with at least one alkyl group with at least 3 carbon atoms, (iii) organic titanates and (iv) organic zirconates and

(b) 0.2 to 5 wt.-%, relative to the magnesium hydroxide, of an aminosilane.

The coating with components (a) and (b) can take place either successively or simultaneously (by using a mixture of the components). If the coating take places in two steps, component (a) is preferably applied first and then component (b), i.e. the aminosilane.

The surface-coated magnesium hydroxides according to the invention are preferably used as a filler in polyamides.

The polyamide compounds characterized in that they contain the surface-coated magnesium hydroxides according to the invention, for example with polyamide 6 as a polyamide component, are also the subject of the invention.

The following examples show the preparation and use of the surface-coated magnesium hydroxides according to the invention, without the specifically realized versions being seen as limitative. The coating was carried out in a Henschel mixer according to a method known per se. The compounding took place in a Buss co-kneader in a manner customary for high-filled plastic systems. The uncoloured type Ultramide® B3L (polyamide 6) of BASF AG was used as a polyamide. The commercially available magnesium hydroxide type MAGNIFIN H 5 IV, coated exclusively with an aminosilane, of Alusuisse Martinswerk GmbH was used as a control. The number 5 denotes a magnesium hydroxide with an average BET value (specific surface area) of 5 m²/g. The magnesium hydroxide MAGNIFIN H 5 of Alusuisse Martinswerk GmbH, which was surface-modified according to the invention with the coating means listed below, was used as an uncoated substrate. The surface modification took place according to methods known per se, as described e.g. in WO-A-00/15710 or WO-A-96/26240. A Henschel mixer was used in each of the examples. The filler was used in a quantity of 55 wt.-% magnesium hydroxide to 45 wt.-% polyamide. Polyamide sheets with a thickness of 3 mm and a surface area of 3×3 cm² were prepared by injection moulding and exposed to the above-described alternating climate. The appraisal of the whitish blooming was carried out after 30, 60 and 90 days by visual assessment. 4 classes were differentiated and rated as follows: 1 (very little film), 2 (little film), 3 (large film) and 4 (very large film).

### EXAMPLE 1

4 different PA compounds were prepared. Compound no. 1 with the filler H 5 IV, which is customary in the trade, served as a reference. It displayed a very large film after only 30 days (rating: 4).

The filler coating of compound no. 2 consisted of in each case 1.0% (relative to the filler) of a lauric acid customary in the trade (Edenor® C12 98-100 of Cognis Deutschland GmbH (formerly Henkel KGaA)) and 3-aminopropyltriethoxysilane (Dynasylan® AMEO of Degussa-Hüls AG). The filler coating of compound no. 3 consisted of in each case 1.0% (relative to the filler) isopropoxy-tris(isostearoyloxy)titanium (TYZOR® ISTT of DuPont de Nemours (Deutschland) GmbH) and 3-aminopropyltriethoxysilane (Dynasylan® AMEO of Degussa-Hüls AG). The filler coating of compound no. 4 consisted of in each case 1.0% (relative to the filler) of a longer-chained alkylsilane (hexadecyltrimethoxysilane, Dynasylan® 9116 of Degussa-Hüls AG) and 3-aminopropyltriethoxysilane (Dynasylan® AMEO of Degussa-Hüls AG).

In the case of compounds 2 to 4, first the fatty acid or the titanate or alkylsilane was applied in a Henschel mixer and then the aminosilane.

The results observed after 30, 60 and 90 days are summarized in the following table 1.

TABLE 1

| Compound | Film after 30 d | Film after 60 d | Film after 90 d |
|---|---|---|---|
| no. | (Scale 1-4) | (Scale 1-4) | (Scale 1-4) |
| 1 | 4 | 4 | 4 |
| (control) | | | |
| 2 | 1 | 2 | 3 |
| 3 | 1 | 2 | 3 |
| 4 | 1 | 2 | 3 |

### EXAMPLE 2

Table 2 shows the influence of the coating sequence on the blooming behaviour after 30 days. In each case 0.5% (relative to the filler) of an industrial-grade behenic acid (docosanoic acid, Prifrac® 2987 of Unichema Chemie GmbH) and 3-aminopropyltriethoxysilane (Dynasylan® AMEO of Degussa-Hüls AG) were used here. For compound 5, the magnesium hydroxide was coated first with the behenic acid and then with the aminosilane, while the opposite sequence was chosen in the case of compound 6. It transpired that considerably better results are achieved if the process according to the invention is carried out such that the behenic acid coating is applied first and then the aminosilane coating.

TABLE 2

| Compound | | Film |
|---|---|---|
| no. | Coating | (Scale 1-4) |
| 1 | only aminosilane (reference) | 4 |
| 5 | 1^{st}) behenic acid, 2^{nd}) | 2 |
| | aminosilane | |
| 6 | 1^{st}) aminosilane, 2^{nd}) behenic | 4 |
| | acid | |

1. Surface coated magnesium hydroxide, in particular for use as filler in polyamides, characterized by a coating containing:
(a) 0.2 to 5 wt. %, based on the magnesium hydroxide, of at least one compound of the group consisting of (i) alkyl silanes having at least one alkyl group with at least 3 carbon atoms and (ii) isopropoxy tris(isostearoyl-oxy) titan, and
(b) 0.2 to 5 wt. %, based on the magnesium hydroxide, of an amino silane.

2. Surface coated magnesium hydroxide according to claim 1, characterized in that it contains as amino silane 3-amino-propyltrimethoxy silane.

3. Surface coated magnesium hydroxide according to claim 1 or 2, characterized in that it contains as alkyl silane a compound of the formula R¹Si(OR²)₃, wherein R¹ is a linear or branched C₃₋₃₀ alkyl and R² is a linear or branched C₁₋₆ alkyl.

4. Surface coated magnesium hydroxide according to claim 3, characterized in that R¹ is a linear or branched C₈₋₂₄ alkyl and R² is a C₁₋₄ alkyl.

5. Surface coated magnesium hydroxide according to any of claims 1 to 4, characterized in that it contains isopropoxy tris(isostearoyloxy) titan.

6. Method for the preparation of a surface coated magnesium hydroxide according to claims 1 to 5, characterized in that untreated magnesium hydroxide is coated in a mixing device with
(a) 0.2 to 5 wt. %, based on the magnesium hydroxide, of at least one compound of the group consisting of (i) alkyl silanes having at least one alkyl group with at least 3 carbon atoms and (ii) isopropoxy tris(isostearoyloxy) titan, and
(b) 0.2 to 5 wt. %, based on the magnesium hydroxide, of an amino silane.

7. Method according to claim 6, characterized in that the coating is at first with component (a) and afterwards with the amino silane.

8. Use of the surface coated magnesium hydroxide according to claims 1 to 5 as filler in polyamides.

9. Polyamide compound, characterized by a content of a surface coated magnesium hydroxide according to claims 1 to 5.
